(19) United States
(12) Patent Application Publication
(10) Pub. No.: US 2005/0283732 A1
(43) Pub. Date: Dec. 22, 2005

(54) Method for controlling a presentation display

(76) Inventor: Andrew J. Menadue, Winchester (GB)

Correspondence Address: LIEBERMAN & BRANDSDORFER, LLC, 802 STILL CREEK LANE, GAITHERSBURG, MD, 20878, US

(21) Appl. No.: 11/154,306

(22) Filed: Jun. 16, 2005

(30) Foreign Application Priority Data
Jun. 16, 2004 (GB) 0413413.6

(51) Int. Cl. G06F 3/00; G06F 15/16

(52) U.S. Cl. 715/747; 715/708; 715/808; 715/844; 715/821; 715/809; 709/217; 709/203; 709/218; 709/227

(57) ABSTRACT

An apparatus, operable to display a plurality of display elements under computer program control, comprises a presentation display component; a memory for storing display element attribute data; and a presentation-only mode control component selectably operable to write and read display element attribute data; wherein the presentation display component is responsive to instruction by the presentation-only mode control component to permit display of display elements having a permission attribute and to suppress display of display elements not having the permission attribute.

### FIELD OF THE INVENTION

The present invention relates to the control of displays, and more particularly to displays on mobile computers used from time to time to give screen-show presentations.

### BACKGROUND OF THE INVENTION

Mobile computers are frequently used to give presentations using applications running on the mobile computer to generate, for example, “slides” to be displayed. These presentations are displayed to an audience by attaching the normal video output of the mobile computer to a large projector display device, or by gathering a small audience around the normal display device of the mobile computer.

As the normal display device is used, any application can place information on the display while the presentation is in progress. For instance, an instant messaging client can bring up a dialog box with a new message if a network connection is attached. This message box could easily have information that should not be disclosed to the audience viewing the presentation. At the very least the flow of the presentation will be disrupted.

The current way to prevent this happening is to manually ensure that no applications are running when the presentation starts that could interrupt it. However, people may not realize that a particular service is running and thus may forget to stop it.

It is also known, in windowing systems, to control the acquisition of focus by applications. In such systems, if an application has acquired focus, other applications or application instances that are already in operation cannot acquire the focus. However, new applications or instances may begin, and may then preempt the currently displayed application and thus be revealed on the display device.

It would thus be desirable to alleviate the aforementioned disadvantageous potential for inadvertent exposure of confidential information and unwanted interruption of presentations.

### SUMMARY OF THE INVENTION

In one aspect of the invention, a display apparatus is provided having a presentation display component. Memory and a presentation mode component are also provided. The memory stores display element attribute data, and the presentation mode component includes a presentation-only mode that is selectably operable to read and write display attribute data stored in the memory. The presentation display component is responsive to an instruction by the presentation-only mode control component.

In another aspect of the invention, a method is provided for operating a display apparatus via a computer network. A presentation display component is provided, and display element attribute data is stored in memory in communication with the presentation display component. Both reading of writing of display element attribute data occurs in response to control by a presentation-only mode component.

In yet another aspect of the invention, a computer program is provided with a computer useable medium embodying computer useable program code to operate a display apparatus. The program includes code to store display element attribute data in memory in communication with a presentation display component. The program also includes code for reading and writing the display element attribute data in response to a presentation-only mode control component.

In another aspect of the invention, an article is provided with a computer readable signal bearing medium. Instructions are provided in the medium to store display element attribute data in memory in communication with a presentation display component. In addition, instructions are provided in the medium for reading and writing the display element attribute data responsive to a presentation-only mode control component.

Other features and advantages of this invention will become apparent from the following detailed description of the presently preferred embodiment of the invention, taken in conjunction with the accompanying drawings.

### BRIEF DESCRIPTION OF THE DRAWINGS

A preferred embodiment of the present invention will now be described, by way of example only, with reference to the accompanying drawing figures, in which:

FIG. 1 shows in schematic form one type of apparatus in which the present invention may be embodied, and is suggested for printing on the first page of the issued patent;

FIG. 2 illustrates the steps of one preferred embodiment of the present invention in the form of a method of operating an apparatus.

### DETAILED DESCRIPTION OF THE PREFERRED EMBODIMENTS

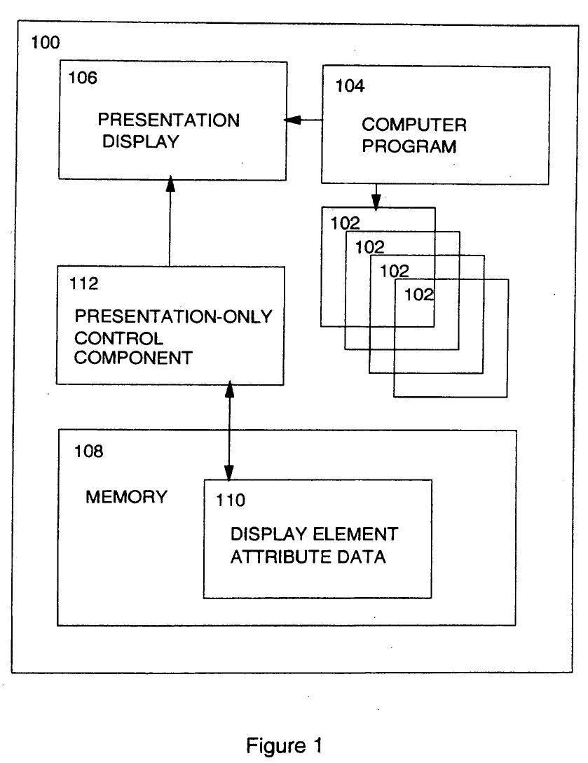

Turning to FIG. 1, there is shown a schematic diagram of an apparatus 100 operable to display a plurality of display elements 102 under computer program 104 control, and comprising a presentation display component 106, a memory 108 for storing display element attribute data 110 and a presentation-only mode control component 112 selectably operable to write and read the display element attribute data.

Presentation display component 106 is responsive to instruction by the presentation-only mode control component 112 to permit display of display elements 102 having a permission attribute in the display element attribute data 110 held in memory 108 and to suppress display of display elements 102 not having the permission attribute.

In one embodiment the presentation-only mode control component 112 may be a programmable function key of said display device programmed in software to perform the required function of controlling the display of display elements 102. In an alternative, the presentation-only mode control component 112 may be a software graphical user interface button control.

In a further alternative, the presentation-only mode control component 112 may be a hardware control physically separate from the apparatus 100 and communicating therewith via a wire or wirelessly, for example, using infrared signal means.

The present invention, thus, provides a dedicated ‘presentation’ button that, when pressed activates a ‘presentation-only’ mode on the mobile computer. When activated, only those applications that have been previously tagged as presentation applications are able to display information on the mobile computer screen (and on any attached presentation device). The dedicated button may be a standard hardware fitting of the device, or may be a separate control device. In an alternative, the equivalent function may be provided in a computer program, by, for example, providing a GUI button control or by providing a configuration setting for a programmable function key on a keyboard or the like.

The present invention could preferably be implemented by adding an attribute to the GUI window definitions so that the window manager can determine whether windows are allowed to be displayed when the ‘Presentation-only’ button has been activated.

When the button is activated all windows that do not have this attribute set are removed from the display (they are hidden, or perhaps minimized or closed), and any windows subsequently requesting to be displayed are screened to see if the attribute is set. If it is not, they are not displayed.

The applications that set this attribute for their windows could be from a family of presentation applications, or the user could set the attributes for applications, or documents could cause the attribute to be set. In a further alternative embodiment, an operating system configuration setting may be provided.

This method also works when showing information on a mobile computer to a small audience directly from the computer screen, for instance price lists or product data in a customer site. It does not rely on applications being information sensitive and careful about what they display as it may preferably cause the lower level window manager to control what is displayed.

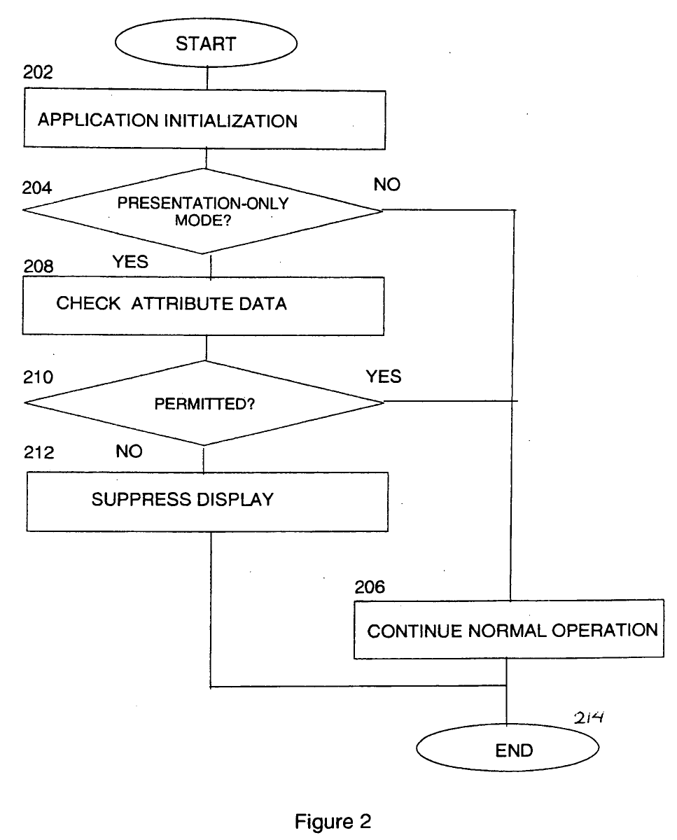

Turning to FIG. 2, there are shown the steps of one embodiment of the present invention in the form of a method of operating an apparatus. As will be clear to one of ordinary skill in the art, such a method may be practiced in hardware, logic arrangements, firmware, software or any combination thereof.

The method steps begin at Start 200. At step 202, an application with one or more display elements 102 is initialized. At step 204 the current state of the system is tested to determine if the presentation-only mode has been enabled. If not, the normal operation of the application continues at step 206. At step 208, the attribute data for the one or more display elements 102 associated with the application is tested. If test 210 finds the permitted attribute, normal processing of the application continues at step 206. If test 210 finds no permitted attribute, at step 212, display is suppressed for the one or more display elements 102 associated with the application. At End step 214 the method completes.

It will be clear to one skilled in the art that the method of the present invention may suitably be embodied in a logic apparatus comprising logic means to perform the steps of the method, and that such logic means may comprise hardware components or firmware components.

It will be appreciated that the method described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

The present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

It will also be appreciated that various further modifications to the preferred embodiment described above will be apparent to a person of ordinary skill in the art.

1. A display apparatus comprising:
a presentation display component;
memory to store display element attribute data;
a presentation-only mode control component selectably operable to read and write said display element attribute data stored in the memory;
wherein said presentation display component is responsive to an instruction by said presentation-only mode control component.

2. The apparatus of claim 1, wherein said instruction permits exhibition of a display element having a permission attribute.

3. The apparatus of claim 1, wherein said instruction suppresses display of a display element without said permission attribute.

4. The apparatus of claim 1, wherein said presentation-only mode control component is a programmable function key of said display device.

5. The apparatus of claim 1, wherein said presentation-only mode control component is a graphical user interface button control.

6. The apparatus of claim 1, wherein said presentation-only mode control component is a hardware control.

7. The apparatus of claim 5, wherein said hardware control communicates with said presentation display component with a connection selected from a group consisting of: wired and wireless.

8. A method for operating a display apparatus comprising:
providing a presentation display component;
storing display element attribute data in memory in communication with said presentation display component; and
reading and writing said display element attribute data responsive to a presentation-only mode control component.

9. The method of claim 8, further comprising permitting exhibition of a display element having a permission attribute.

10. The method of claim 8, further comprising suppressing exhibition of a display element without said permission attribute.

11. The method of claim 8, wherein said presentation-only mode control component is a programmable function key of said display device.

12. The method of claim 8, wherein said presentation-only mode control component is a graphical user interface button control.

13. The method of claim 8, wherein said presentation-only mode control component is a hardware control.

14. The method of claim 13, wherein said hardware control communicates with said presentation display component with a connection selected from a group consisting of: wired and wireless.

15. A computer program product comprising:
a computer useable medium embodying computer usable program code for operating a display apparatus, said computer program product including:
computer useable program code for storing display element attribute data in memory in communication with a presentation display component; and
computer useable program code for reading and writing said display element attribute data responsive to a presentation-only mode control component.

16. The computer program product of claim 15, further comprising computer usable program code for permitting exhibition of a display element having a permission attribute.

17. The computer program product of claim 15, further comprising computer useable program code for suppressing exhibition of a display element without said permission attribute.

18. The computer program product of claim 15, wherein said presentation-only mode control component is selected from a group consisting of: a programmable function key of said display device, a graphical user interface button control, and a hardware control.

19. The computer program product of claim 18, wherein said hardware control communicates with said presentation display component with a connection selected from a group consisting of: wired and wireless.

20. An article comprising:
a computer readable signal bearing medium;
instructions in said medium for storing display element attribute data in memory in communication with a presentation display component; and
instructions in said medium for reading and writing said display element attribute data responsive to a presentation-only mode control component.
